(19) United States
(12) Patent Application Publication
(10) Pub. No.: US 2009/0274191 A1
(43) Pub. Date: Nov. 5, 2009

(54) SINGLE BEAM OPTICAL APPARATUS AND METHOD

(76) Inventors: Alain Hache, Moncton (CA); Michel Deveau, Moncton (CA)

Correspondence Address: STIKEMAN ELLIOTT LLP, 1600-50 O''CONNOR STREET, OTTAWA, ON, KIP 6L2, CA

(21) Appl. No.: 12/428,001

(22) Filed: Apr. 22, 2009

Related U.S. Application Data
(60) Provisional application No. 61/046,975, filed on Apr. 22, 2008.

(51) Int. Cl. G01N 25/20

(52) U.S. Cl. 374/43

(57) ABSTRACT

A single-beam optical apparatus suitable for measuring thermal diffusivity of a sample having a laser source generating a focused laser beam capable of heating a portion of the sample so as to create a thermal bump via thermal dilation, the thermal bump reflecting a reflected portion of the focused laser beam, means for modulating the intensity of the laser beam, an aperture, a sensor positioned relative to the reflected portion of the focused laser beam so as to generate a measured signal from the reflected portion of the focused laser beam that passes through the aperture, and a module for determining at least the parameters of a relationship between a property of the thermal bump and the measured signal.

### CROSS-REFERENCE TO RELATED APPLICATIONS

This application claims the benefit of U.S. Provisional Application Ser. No. 61/046,975 filed Apr. 22, 2008.

### MICROFICHE APPENDIX

Not applicable.

### TECHNICAL FIELD

This application relates to apparatus and methods for studying the thermal properties of solids and liquids using optical beams in general, and to a single beam optical apparatus and method for measuring thermal conductivity and diffusivity of solid and liquid samples, in particular.

### BACKGROUND OF THE INVENTION

Techniques of reflective thermal lensing for measuring thermal diffusivity in solids and liquids are known. The measurement for liquid samples has been made possible by the use of reflection lensing measurements in thin chromium and beryllium films deposited on glass substrates. For a review and description of such techniques, see for example “Reflective thermal lensing and optical measurement of thermal diffusivity in liquids”, Daniel Comeau, Alain Hache, and Noureddine Melikechi, Applied Physics Letters, Volume 83, Number 2, pp. 246-248, 2003.

One approach to extracting thermal properties is to study the time-evolution of a probe beam reflected on thermal bump (created by focusing a second, stronger and modulated pump beam on the sample), which is reflected through a circular aperture. For a description of this technique, see for example “Time evolution of reflective thermal lenses and measurement of thermal diffusivity in bulk solids”, Serge Doiron and Alain Haché, Applied Optics, Volume 43, Number 21, pp. 4250-4253, 2004.

One problem with known techniques is that a relatively large amount of material is needed to accurately measure thermal properties of a sample, such as thermal diffusivity.

Another problem with known techniques is that measurements can take a relatively long amount of time.

Yet another problem with known techniques is that convection effects of liquid samples may limit the accuracy of thermal measurements.

Still another problem with known techniques is that they are not versatile, meaning that they may not apply to varied samples, such as solid or liquid samples, or opaque and transparent samples.

Another problem with two-beams techniques is sensitivity to misalignment and vibrations.

### SUMMARY

The present technique enables several advantages over known techniques. First, a focused laser beam is used as a source of heat, which means that a very small volume of sample material is probed. The amount of sample material needed to accurately measure thermal diffusivity is thereby decreased by a factor of around 10⁶ compared to standard techniques. Moreover, the need for a second pump beam is unnecessary, as the focused beam can contemporaneously function as both a pump and probe beam. Secondly, measurement can be done quickly (in about 5 milliseconds), as opposed to the seconds or minutes in known techniques. Since a small volume is probed, convection effects in liquids are limited (convection adds to conduction effects and limits the accuracy of measurement). Finally, the present technique is versatile as it applies both to liquid and solid samples, and either opaque or transparent materials.

According to one aspect of the present invention, there is provided: a single-beam optical apparatus suitable for measuring thermal diffusivity of a sample, the apparatus comprising: (a) a laser source generating a laser beam capable of heating a portion of the sample so as to create a thermal bump via thermal dilation, the thermal bump reflecting a portion of the focused laser beam, which then passes through the aperture; (b) a means for modulating the laser beam by mechanical means (e.g. chopper), electro-optically (e.g. Pockel cell) or otherwise; (c) a sensor positioned relative to the reflected portion of the focused laser beam so as to generate a measured signal from the reflected portion of the focused laser beam; and (d) a module for determining at least the parameters of a relationship between a property of the thermal bump and the measured signal.

According to another aspect of the present invention, there is provided: a single-beam optical method suitable for measuring thermal diffusivity of a sample, the method comprising the steps of: (a) generating a focused laser beam; (b) modulating the latter beam; (c) heating a portion of the sample using the focused laser beam; (d) creating a thermal bump via thermal dilation as a result of the heating step; (e) reflecting a reflected portion of the focused laser beam off of the thermal bump; (f) generating a measured signal from the reflected portion of the focused laser beam; and (g) determining at least the parameters of a relationship between a property of the thermal bump and the measured signal.

Other aspects and features of the present invention will become apparent to those ordinarily skilled in the art upon review of the following description of specific embodiments of a single beam optical apparatus and method in conjunction with the accompanying drawing figures.

### BRIEF DESCRIPTION OF THE DRAWINGS

Embodiments of the present invention will now be described, by way of example only, with reference to the accompanying drawing figures, wherein:

FIG. 1 illustrates a single-beam optical apparatus provided in accordance with one embodiment of the present invention;

FIG. 2 illustrates a single-beam optical apparatus provided in accordance with one embodiment of the present invention;

FIG. 3 illustrates a laser beam incident on a substrate;

FIG. 4 depicts a side view (along the y-axis) of FIG. 3;

FIG. 5 illustrates a typical photodiode signal curve obtained in accordance with one embodiment of the present invention; and

FIG. 6 is a graph of thermal diffusivities obtained in accordance with one embodiment of the invention compared to published sources;

Like reference numerals are used in different figures to denote similar elements.

### DETAILED DESCRIPTION OF THE DRAWINGS

### Single Pump-Probe Beam Apparatus

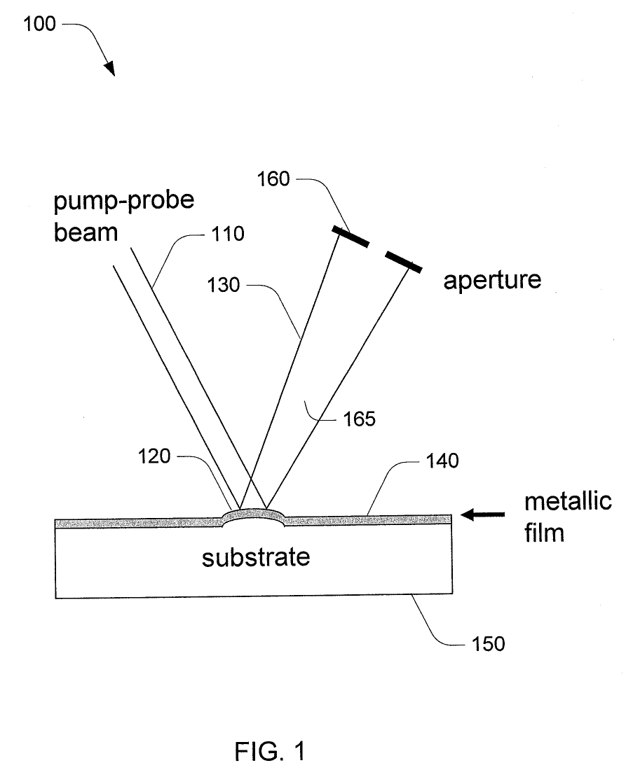

Referring to the drawings, FIG. 1 illustrates a single-beam optical apparatus provided in accordance with one embodiment of the present invention. A first embodiment of single-beam optical apparatus 100 is suitable for measuring thermal diffusivity or conductivity of a sample (substrate). In FIG. 1, a laser source (not shown) generates a kind of focused laser beam, in this case a pump-probe beam 110, capable of heating a portion of a sample (not shown) so as to create a thermal bump 120 via thermal dilation, the thermal bump reflecting a reflected portion 130 of the focused laser beam. A sensor (not shown) is positioned relative to the reflected portion 130 of the focused laser beam so as to generate a measured signal from the reflected portion of the focused laser beam. A module (not shown) is used for determining at least the parameters of a relationship between a property of the thermal bump 120 and the measured signal.

In alternate embodiments, the thin film 140 is sandwiched between a liquid (not shown) and the substrate 150, or between the substrate 150 and air.

In alternate embodiments, the thin film 140 is made of chromium, beryllium or any partially absorbent material.

In one embodiment, a sensor (not shown) includes a photodiode (not shown) and an aperture 160 positioned between the thermal bump 120 and the photodiode, so that light goes through the aperture 160 to the photodiode according to a substantially linear function of the height of the thermal bump 160. As the reflected portion 130 of the focused laser beam diverges 165 as a result of the thermal bump 120 height increasing, less light goes through the aperture 160 and the signal at the photodiode drops.

In one embodiment, the relationship between a property of the thermal bump 120 and the measured signal is substantially s=A×(1−B×h), wherein the measured signal is s, the property of the thermal bump 120 is a height of the thermal bump h, and A and B are the parameters of the relationship which are at least determined by a module (not shown). The module can further determine the height of the thermal bump from the measured signal.

In one embodiment, the relationship between a property of the thermal bump 120 and the measured signal is substantially s=A (1−BT), wherein the measured signal is s, the property of the thermal bump 120 is a temperature of the thermal bump T, and A and B are the parameters of the relationship which are at least determined by a module (not shown). The module can further determine the temperature of the thermal bump from the measured signal.

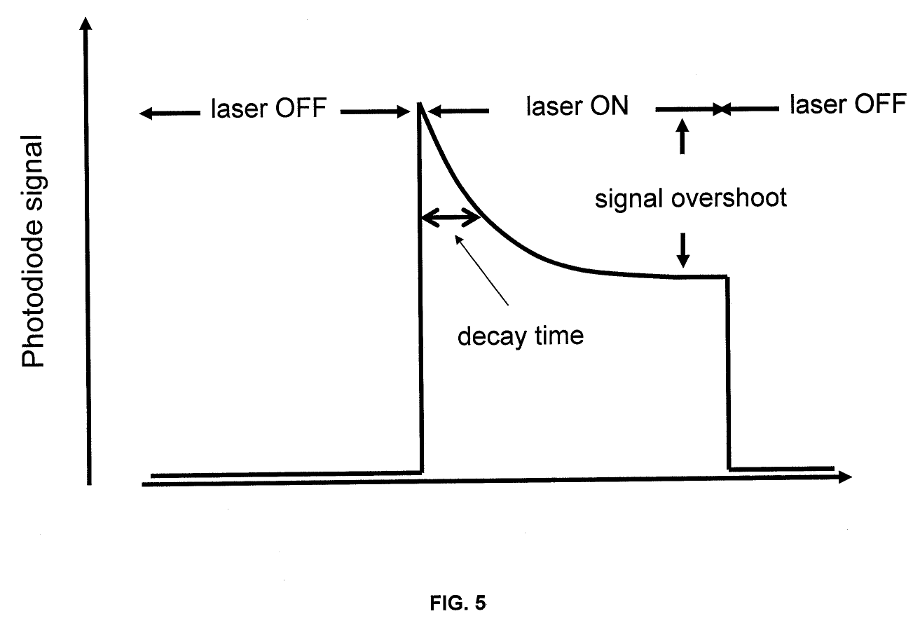

In one embodiment, the thermal diffusivity is extracted directly from the photodiode signal. When the laser beam is blocked or switched off, the photodiode signal is nil. When the laser beam is unblocked or switched on, the laser beam reflects off the sample and reaches the photodiode, thereby giving a non-zero signal. As heat accumulates in the sample, a thermal bump appears which causes the reflected beam to diverge. Divergence causes the photodiode signal to drop, as less of the beam passes through the aperture. How quickly the thermal bump rises (signal drops) is directly related to the rate of dissipation of heat into the sample, which depends on thermal diffusivity. The decay time of the signal (see FIG. 5) is uniquely and directly related to the sample's thermal diffusivity. The exact relationship must be found by calibration with several materials whose thermal diffusivity is known. The relationship is a function of at least one of the focused laser beam spot size, a position of the sample, and the width of an aperture.

The apparatus is versatile as the sample can be a solid or a liquid, and be opaque or transparent.

In one embodiment, the module further determines the thermal diffusivity of the sample as a function of the time evolution of the relationship between the property of the thermal bump and the measured signal.

### Example Applicability to Solid, Liquid, and Opaque Materials

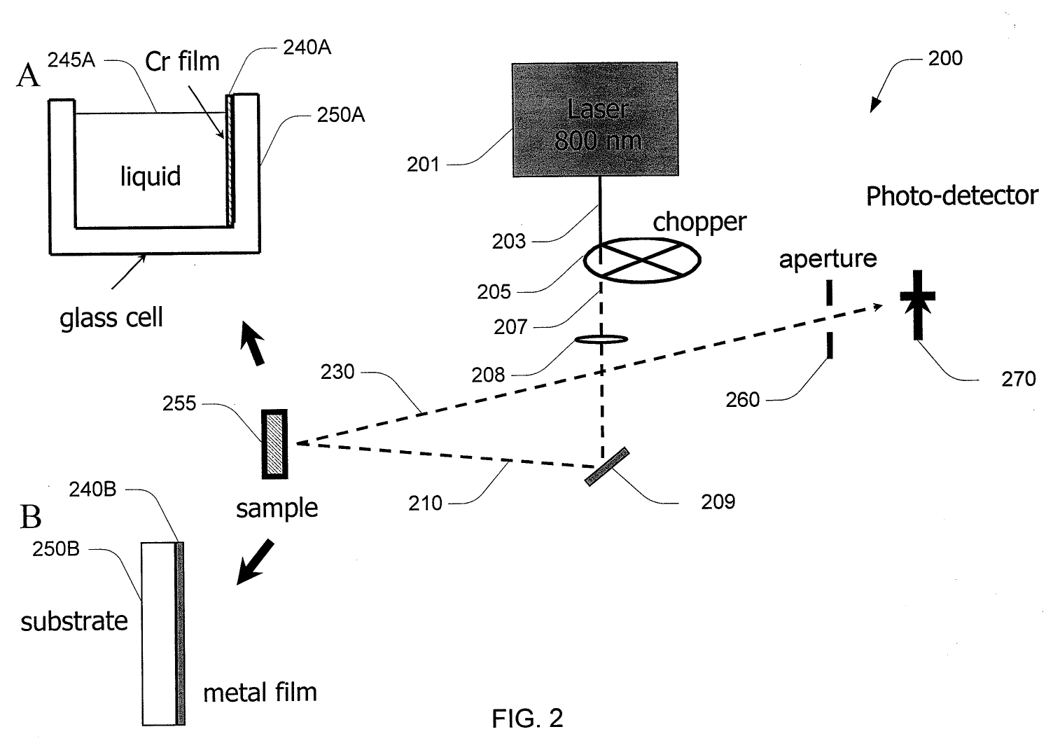

Referring to the second sheet of the drawings, FIG. 2 illustrates a single-beam optical apparatus provided in accordance with one embodiment of the present invention. A second embodiment of single-beam optical apparatus 200 is suitable for measuring thermal diffusivity of a sample 255, 255A, 255B. In FIG. 2, a laser source 201 generates a source laser beam 203, which is then chopped by chopper 205 to provide a chopped beam 207, focused by lens 208 into a focused laser beam, in this case a pump-probe beam 210 which is reflected by mirror 208 onto sample 255, 255A, 255B. The pump-probe mean 210 is capable of heating a portion of the sample 255, 255A, 255B so as to create a thermal bump (not shown) via thermal dilation, the thermal bump reflecting a reflected portion 230 of the focused laser beam. A sensor 270 is positioned relative to the reflected portion 230 of the focused laser beam which passes through iris 260 so as to generate a measured signal from the reflected portion of the focused laser beam. A module (not shown) is used for determining at least the parameters of a relationship between a property of the thermal bump and the measured signal.

Two alternate illustrative examples embodiments of sample 255 are shown. In alternative A, a thin film 240A is sandwiched between the sample 245A and the substrate 250A. In alternative B, a thin film 240B is sandwiched between the substrate 250B and air.

In alternate embodiments, the thin film is made of chromium, beryllium or any partially absorbent material.

In one embodiment, a sensor includes a photodiode 270 and an aperture 260 positioned between the thermal bump (not shown) and the photodiode 270, so that light goes through the aperture 260 to the photodiode 270 according to a substantially linear function of the height of the thermal bump. As the reflected portion 230 of the focused laser beam diverges (not shown) as a result of the thermal bump height increasing (not shown), less light goes through the aperture 260 and the signal at the photodiode 270 drops.

In one embodiment, the relationship between a property of the thermal bump and the measured signal is substantially s=A(1−Bh), wherein the measured signal is s, the property of the thermal bump is a height of the thermal bump h, and A and B are the parameters of the relationship which are at least determined by a module (not shown). The module can further determine the height of the thermal bump from the measured signal.

In one embodiment, the relationship between a property of the thermal bump and the measured signal is substantially s=A(1−BT), wherein the measured signal is s, the property of the thermal bump is a temperature of the thermal bump T, and A and B are the parameters of the relationship which are at least determined by a module (not shown). The module can further determine the temperature of the thermal bump from the measured signal.

In one embodiment, the parameters of the relationship which are at least determined by the module are determined as a function of experimental arrangements by calibration. The parameters are determined as function of at least one of the focused laser beam spot size, a position of the sample relative to the beam focal point, and the width of an aperture.

The apparatus is versatile as the sample 255 can be a solid or a liquid, and be opaque or transparent.

In one embodiment, the module further determines the thermal diffusivity of the sample as a function of the time evolution of the relationship between the property of the thermal bump and the measured signal.

### Finite Difference Technique

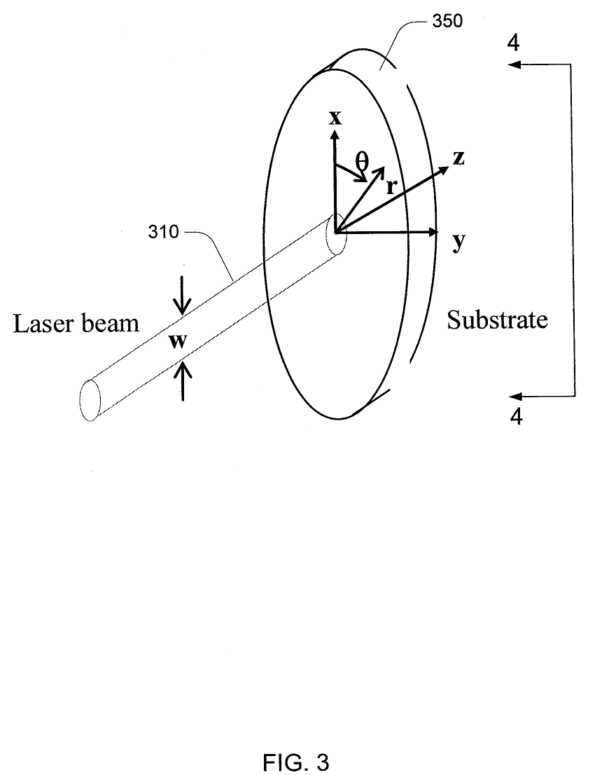

FIG. 3 illustrates a laser beam incident on a substrate. A laser 310 having a beam width w (defined as the full-width at half-maximum, and assuming a laser with a Gaussian distribution) is aimed at a substrate 350 with conductivity κ, density ρ and specific heat at constant pressure cₚ.

In general, the “balanced” heat transfer equation within the substrate is given as:

$$ρ {c}_{p} \frac{\partial T}{\partial t} = κ {∇}^{2} T + Q \qquad Equation 1$$

where Q is the heat per volume per unit of time being pumped in the substrate by the laser. The laser beam 310 is assumed to transfer its energy only at the substrate 350 surface (z=0) and to have a “radial” Gaussian profile. Therefore, Q(r,z)=0 for z>0 and non-zero at z=0.

We can therefore write:

$$Q ( r ) = {Q}_{0} exp ( - 4 ln ( 2 ) \frac{{r}^{2}}{{w}^{2}} ) \qquad Equation 2$$

where Qₒ is the power per unit of volume pumped at the center of the laser (r=0), which can be found with the following relation:

$$Δ z {\int }_{0}^{∞} 2 π r Q ( r , 0 ) d r = ( 1 - R ) {P}_{o} \qquad Equation 3$$

where Δz is the metal film thickness, R is the reflectivity of the thin film, and Pₒ is the laser beam power incident on the sample. Equation 3 states that the heat deposited at the sample's surface is equal to the portion of the laser beam energy that is absorbed by the film (transmittance through the film is taken to be negligible). From Equations 2 and 3 we obtain

$${Q}_{0} = \frac{2 {P}_{max}}{ln ( 2 ) π {w}^{2} Δ z} \qquad Equation 4$$

We express the Laplacian found in Equation 1 in cylindrical coordinates (imposing rotational symmetry) as:

$${∇}^{2} = \frac{\partial }{\partial {r}^{2}} + \frac{1}{r} \frac{\partial }{\partial r} + \frac{\partial }{\partial {z}^{2}} \qquad Equation 5$$

We can therefore write the heat transfer equation (Equation 1) as:

$$ρ {c}_{p} \frac{\partial T ( r , z , t )}{\partial t} = κ ( \begin{matrix}\frac{{\partial }^{2} T ( r , z , t )}{\partial {r}^{2}} + \\ \frac{1}{r} \frac{\partial T ( r , z , t )}{\partial r} + \\ \frac{{\partial }^{2} T ( r , z , t )}{\partial {z}^{2}}\end{matrix} ) + Q ( r , z ) \qquad Equation 6$$

Using Taylor expansion, we can write the following expressions for estimating the first and second derivatives.

$$\begin{matrix} \frac{\partial T ( r , z , t )}{\partial t} \approx \frac{T ( r , z , t + Δ t ) - T ( r , z , t )}{Δ t} & Equation 7 \\ {T}_{r} ( r , z , t ) ≡ \frac{1}{r} \frac{\partial T ( r , z , t )}{\partial r} \approx \frac{1}{r} \frac{T ( r + Δ r , z , t ) - T ( r , z , t )}{Δ r} & Equation 8 \\ {T}_{rr} ( r , z , t ) ≡ \frac{{\partial }^{2} T ( r , z , t )}{\partial {r}^{2}} \approx \frac{\begin{matrix}T ( r + Δ r , z , t ) - 2 T ( r , z , t ) + \\ T ( r - Δ r , z , t )\end{matrix}}{Δ {r}^{2}} & Equation 9 \\ {T}_{zz} ( x , z , t ) ≡ \frac{{\partial }^{2} T ( x , z , t )}{\partial {z}^{2}} \approx \frac{\begin{matrix}T ( x , z + Δ z , t ) - 2 T ( x , z , t ) + \\ T ( x , z - Δ z , t )\end{matrix}}{Δ {z}^{2}} & Equation 10\end{matrix}$$

where Δt, Δz and Δr are infinitesimal increments of time, position and radial position, respectively.

This allows us to estimate the temperature at a later time t+Δt:

$$T ( r , z , t + Δ t ) = T ( r , z , t ) + [ \begin{matrix}κ ( \begin{matrix}{T}_{rr} ( r , z , t ) + \\ {T}_{r} ( r , z , t ) + \\ {T}_{zz} ( r , z , t )\end{matrix} ) + \\ {Q}_{0} exp ( - 4 ln ( 2 ) \frac{{r}^{2}}{{w}^{2}} )\end{matrix} ] \frac{Δ t}{ρ {c}_{p}} \qquad Equation 11$$

### Defining the Grid and Finding the Iterative Formula

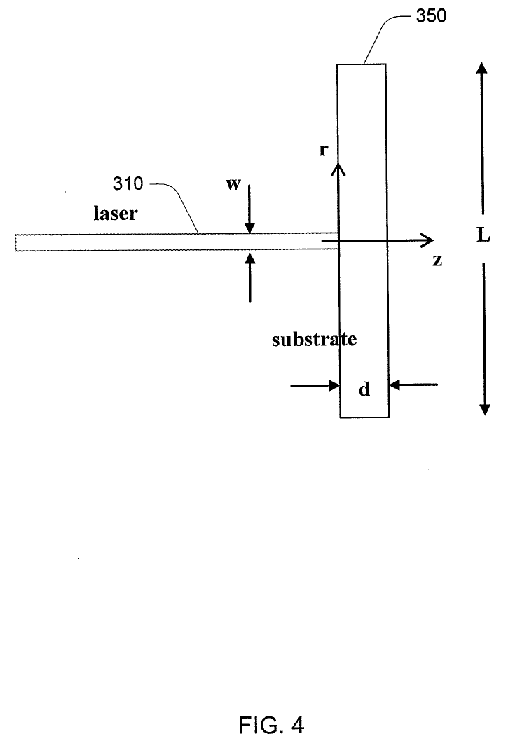

FIG. 4 depicts a side view (along the y-axis) of FIG. 3. Because of the circular symmetry of the Gaussian beam, only two coordinates need to be taken into account, namely z and r. The substrate 350 is divided into a grid having nᵣ n_{z} points. This allows us to define the following:

$$\begin{matrix}Δ r = \frac{1}{2} \frac{L}{{n}_{r} - 1} & Equation 12 \\ and \text{:} & \\ Δ z = \frac{d}{{n}_{z} - 1} & Equation 13\end{matrix}$$

Points on the grid are computed as:

r=iΔr i=0 . . . nᵣ−1 Equation 14

and:

z=jΔz j=0 . . . n_{z}−1 Equation 4

Points in time are computed using:

t=kΔt k=0 . . . nₜ−1 Equation 5

We can therefore write:

$${T}_{i , j , k + 1} = {T}_{i , j , k} + [ \begin{matrix}κ ( \begin{matrix}{T}_{rr i , j , k} + \\ {T}_{r i , j , k} + \\ {T}_{zz i , j , k}\end{matrix} ) + \\ {Q}_{0} exp ( - 4 ln ( 2 ) \frac{{( i Δ r )}^{2}}{{w}^{2}} ) {δ}_{j 0}\end{matrix} ] \frac{Δ t}{ρ {c}_{p}} \qquad Equation 17$$

where δⱼ₀=1 for j=0 and δⱼ₀=0 otherwise.
also,

$$\begin{matrix}{T}_{r i , j , k} = \frac{{T}_{i + 1 , j , k} - {T}_{i , j , k}}{i Δ {r}^{2}} 0 < i < {n}_{r} - 1 & Equation 18 \\ {T}_{rr i , j , k} = \frac{{T}_{i + 1 , j , k} - 2 {T}_{i , j , k} + {T}_{i - 1 , j , k}}{Δ {r}^{2}} 0 < i < {n}_{r} - 1 & Equation 19 \\ {T}_{zz i , j , k} = \frac{{T}_{i , j + 1 , k} - 2 {T}_{i , j , k} + {T}_{i , j - 1 , k}}{Δ {z}^{2}} 0 < j < {n}_{z} - 1 & Equation 20\end{matrix}$$

### Initial and Boundary Conditions

We start by imposing that T(r,z,t)=T₀, the ambient temperature, at t=0. We therefore have:

T_{i,j,0}=T₀ Equation 21

We then impose that the heat absorption from the laser is at substrate boundary z=0. This gives:

$${T}_{i , 0 , k + 1} = \{ \begin{matrix}\begin{matrix}{T}_{0 , 0 , k} + [ κ ( \begin{matrix}{T}_{rr 0 , 0 , k} + \\ {T}_{r 0 , 0 , k} + \\ {T}_{zz 0 , 0 , k}\end{matrix} ) + {Q}_{0} ] \frac{Δ t}{ρ {c}_{p}} & i = 0 , j = 0 \end{matrix} \\ \begin{matrix}{T}_{i , 0 , k} + [ \begin{matrix}κ ( \begin{matrix}{T}_{rr 0 , 0 , k} + \\ {T}_{r 0 , 0 , k} + \\ {T}_{zz 0 , 0 , k}\end{matrix} ) + \\ {Q}_{0} exp ( - \frac{4 ln ( 2 )}{{w}^{2}} {( i Δ r )}^{2} )\end{matrix} ] \frac{Δ t}{ρ {c}_{p}} & i > 0 , j = 0\end{matrix}\end{matrix} \qquad Equation 22$$

We then impose that the temperature at the other substrate boundaries and outside the substrate volume remains T=T₀. This gives:

T_{i,j,k+1}=T_{i,j,0} i<0,i=nᵣ−1 or j=n_{z}−1 Equation 23

Everywhere else, we have:

$${T}_{i , j , k + 1} = {T}_{i , j , k} + κ ( {T}_{rr i , j , k} + {T}_{r i , j , k} + {T}_{zz i , j , k} ) \frac{Δ t}{ρ {c}_{p}} \\ i \neq {n}_{r} - 1 , j \neq 0 and j \neq {n}_{z} - 1 \qquad Equation 24$$

It is apparent from Equation 18, that there will be a singularity at r=0 if we use that form for computing the Laplacian. We instead approximate the radial temperature profile as a quadratic, knowing that T(r,z,t)=T(−r,z,t). We can therefore write (around r=0):

$$T ( r , z , t ) = {a}_{0} + {a}_{2} {r}^{2} \to \frac{1}{r} \frac{\partial T}{\partial r} = 2 {a}_{2} \qquad Equation 25$$

where a₀=T_{0,j,k} and a₂=T_{1,j,k}−T_{0,j,k}.

Using this special treatment around the pole, we can write:

$$\begin{matrix}{T}_{r i , j , k} = \{ \begin{matrix}\frac{2 ( {T}_{1 , j , k} - {T}_{0 , j , k} )}{Δ {r}^{2}} & i = 0 \\ \frac{{T}_{i + 1 , j , k} - {T}_{i , j , k}}{i Δ {r}^{2}} & 0 < i < {n}_{r} - 1\end{matrix} & Equation 26 \\ {T}_{rr i , j , k} = \{ \begin{matrix}\frac{2 ( {T}_{1 , j , k} - {T}_{0 , j , k} )}{Δ {r}^{2}} & i = 0 \\ \frac{{T}_{i + 1 , j , k} - 2 {T}_{i , j , k} + {T}_{i - 1 , j , k}}{Δ {r}^{2}} & 0 < i < {n}_{r} - 1\end{matrix} & Equation 27 \\ {T}_{zz i , j , k} = \frac{{T}_{i , j + 1 , k} - 2 {T}_{i , j , k} + {T}_{i , j - 1 , k}}{Δ {z}^{2}} 0 < j < {n}_{z} - 1 & Equation 28\end{matrix}$$

Relationship between the Surface Temperature Profile and the Measured Signal

The instrument bases its measurements on the reflected portion of the laser beam that is heating the sample. This reflected beam goes through a circular aperture then to photodiode that measures the power transmitted through the aperture. Whenever the beam diverges as a result of the thermal bump, less light goes through the aperture and the signal drops. There is, therefore, an inverse relationship between the height of the thermal bump and the amount of light reaching the detector. To first order, one can then assume a relationship of the form:

s=A(1−Bh) Equation 29

where A and B are positive constants, s is the photodiode signal measurement and h is the height of the thermal bump.

Also, to first order, one can assume a linear relationship between h and the local temperature T where the laser touches the sample. This is because the thermal expansion is linear with temperature. The previous equation then becomes:

s=C(1−Dh) Equation 30

where C and D are constants. Equation 30 is the basic link between our instrument measurements and the calculated temperature. We fit the temperature calculated of the center of heated bump to the measured signal via Equation 30. This is an approximation, but by adjusting A and B (or C and D), a curve that matches the data very well can usually be found.

It is important to note that parameters A and B (or C and D) do not by themselves give the information about the thermal diffusivity of the underlying substrate. Rather, they enable one to calculate the temperature profile on the sample based on the signal measured on the photodiode. Diffusivity is extracted from the time-evolution of the signal. This signal evolution is measured with the photodiode, then fitted with the described model. Once the best fit is obtained, the decay time is determined: the quicker T decays, the more conductive the sample is. Note that A and B (or C and D) do not change from one sample to another, but they must be recalculated if experimental arrangements are changed (beam spot size, sample position, aperture width, etc.).

FIG. 5 illustrates a typical photodiode signal obtained with the embodiment described in FIG. 2. When the laser is unblocked by the chopper (or switched ON), the signal is initially maximum since the beam has not diverged yet. As the thermal bump grows, the beam diverges and the portion of is passing through the circular aperture and reaching the photodiode decreases. This creates a signal “overshoot” that then decays at a rate that is directly related to the thermal diffusivity of the substrate (or the metal film surroundings if the latter is sandwiched between different materials). The signal trace is fitted very well to the described model, therefore enabling one to precisely determine the decay time constant.

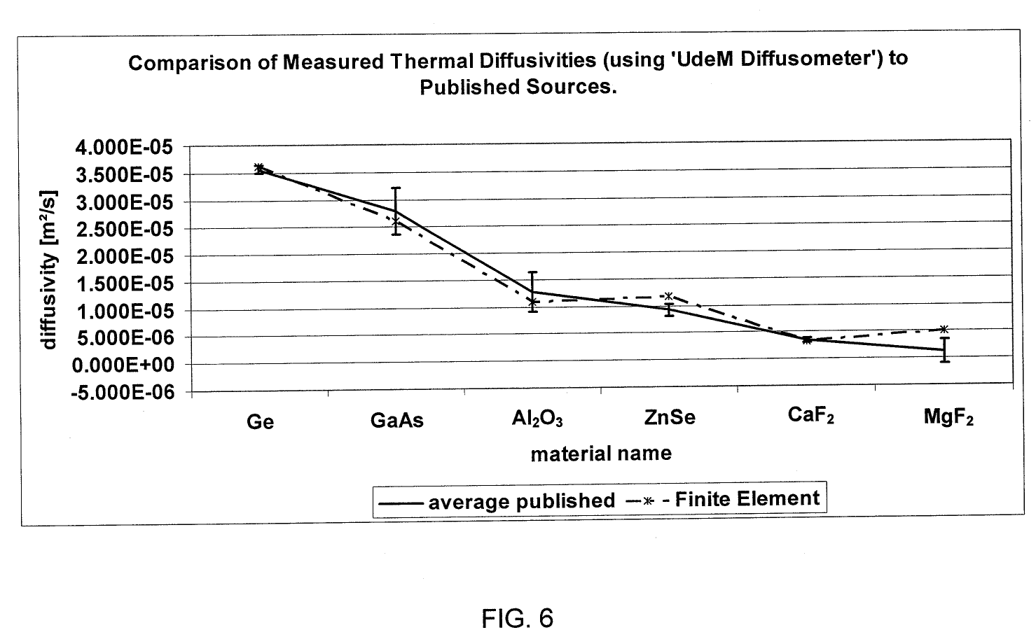

FIG. 6 illustrates a good agreement between the measured diffusivity in various solids using the described technique and the values provided elsewhere. Note that error bars represent the spread of values reported in the literature. In all cases, the measured diffusivity is within or very close to error bars.

The above-described embodiments of the present invention are intended to be examples only. Those of skill in the art may effect alterations, modifications and variations to the particular embodiments without departing from the scope of the invention, which is set forth in the claims.

What is claimed is:

1. A single-beam optical apparatus suitable for measuring thermal diffusivity of a sample, the apparatus comprising:
a laser source generating a focused laser beam capable of heating a portion of the sample so as to create a thermal bump via thermal dilation, the thermal bump reflecting a reflected portion of the focused laser beam;
means for modulating the intensity of the laser beam;
an aperture;
a sensor positioned relative to the reflected portion of the focused laser beam so as to generate a measured signal from the reflected portion of the focused laser beam that passes through the aperture; and
a module for determining at least the parameters of a relationship between a property of the thermal bump and the measured signal.

2. The apparatus as recited in claim 1, further comprising a thin film sandwiched between the sample and a substrate.

3. The apparatus as recited in claim 2, wherein the thin film comprises a partially absorbing material.

4. The apparatus as recited in claim 2, wherein the metal is chromium or beryllium.

5. The apparatus as recited in claim 1, wherein the sensor comprises a photodiode and an aperture positioned between the thermal bump and the photodiode, so that light goes through the aperture to the photodiode according to a substantially linear function of the height of the thermal bump, whereby as the reflected portion of the focused laser beam diverges as a result of the thermal bump height increasing, less light goes through the aperture and the signal at the photodiode drops.

6. The apparatus as recited in claim 1, wherein the relationship between a property of the thermal bump and the measured signal is substantially s=A(1−Bh), wherein the measured signal is s, the property of the thermal bump is a height of the thermal bump h, and A and B are the parameters of the relationship which are at least determined by the module, so that the module can further determine the height of the thermal bump from the measured signal.

7. The apparatus as recited in claim 1, wherein the relationship between a property of the thermal bump and the measured signal is substantially s=C(1−Dh), wherein the measured signal is s, the property of the thermal bump is a temperature of the thermal bump T, and C and D are the parameters of the relationship which are at least determined by the module, so that the module can further determine the temperature of the thermal bump from the measured signal.

8. The apparatus as recited in claim 1, wherein the parameters of the relationship which are at least determined by the module are determined as a function of experimental arrangements by calibration as a function of at least one of the focused laser beam spot size, a position of the sample, and the width of an aperture.

9. The apparatus as recited in claim 1, wherein the sample is one of a solid or a liquid.

10. The apparatus as recited in claim 1, wherein the sample is one of opaque or transparent.

11. The apparatus as recited in claim 1, wherein the module further determines the thermal diffusivity of the sample as a function of the time evolution of the relationship between the property of the thermal bump and the measured signal.

12. A single-beam optical method suitable for measuring thermal diffusivity of a sample, the method comprising the steps of:
(a) generating a focused laser beam;
(b) modulating the laser beam;
(c) heating a portion of the sample using the focused laser beam;
(d) creating a thermal bump via thermal dilation as a result of the heating step;
(e) reflecting a reflected portion of the focused laser beam off of the thermal bump;
(f) generating a measured signal from the reflected portion of the focused laser beam; and
(g) determining at least the parameters of a relationship between a property of the thermal bump and the measured signal.

13. The method as recited in claim 12, further comprising the step of providing a thin film sandwiched between the sample and a substrate.

14. The method as recited in claim 13, wherein the thin film comprises at least one of chromium or beryllium.

15. The method as recited in claim 12, further comprising the step of determining the divergence of the reflected portion of the focused laser beam that occurs as a result of the thermal bump height increasing.

16. The method as recited in claim 12, wherein the relationship between a property of the thermal bump and the measured signal is substantially s=A(1−Bh), wherein the measured signal is s, the property of the thermal bump is a height of the thermal bump h, and A and B are the parameters of the relationship which are at least determined by the module, so that the module can further determine the height of the thermal bump from the measured signal.

17. The method as recited in claim 12, wherein the relationship between a property of the thermal bump and the measured signal is substantially s=C(1−DT), wherein the measured signal is s, the property of the thermal bump is a temperature of the thermal bump T, and C and D are the parameters of the relationship which are at least determined by the module, so that the module can further determine the temperature of the thermal bump from the measured signal.

18. The method as recited in claim 12, wherein the step of determining at least the parameters of a relationship between a property of the thermal bump and the measured signal comprises the act of simulating thermal diffusion driven by laser heating.

19. The method as recited in claim 18, wherein the act of simulating thermal diffusion driven by laser heating uses the finite difference algorithm.

20. The method as recited in claim 18, wherein the act of simulating thermal diffusion driven by laser heating uses a model for the single-beam laser and sample.

21. The method as recited in claim 16, wherein the estimator for the heat transfer equation includes a power per unit volume term which assumes that the laser beam transfers its energy at the substrate surface according to a radial Gaussian distribution.

22. The method as recited in claim 12, wherein the parameters of the relationship which are at least determined by the module are determined as a function of experimental arrangements by calibration as a function of at least one of the focused laser beam spot size, a position of the sample, and the width of an aperture.

23. The method as recited in claim 12, wherein the sample is one of a solid and a liquid.

24. The method as recited in claim 12, wherein the sample is opaque or transparent.

25. The method as recited in claim 12, further comprising the step of determining the thermal diffusivity of the sample as a function of the time evolution of the relationship between the property of the thermal bump and the measured signal.
